(19) United States
(12) Patent Application Publication
(10) Pub. No.: US 2021/0184247 A1
(43) Pub. Date: Jun. 17, 2021

(54) 6Li BATTERY

(71) Applicant: The Aerospace Corporation, El Segundo, CA (US)

(72) Inventors: Eric Joseph NEMANICK, Santa Monica, CA (US); Brian SHEN, Hawthorne, CA (US)

(73) Assignee: The Aerospace Corporation

(21) Appl. No.: 16/712,959

(22) Filed: Dec. 12, 2019

(51) Int. Cl. H01M 10/0525; H01M 10/0566; H01M 4/58; H01M 4/505; H01M 4/525

(52) U.S. Cl. CPC H01M 10/0525; H01M 10/0566; H01M 4/525; H01M 4/505; H01M 4/5825

(57) ABSTRACT

A battery may include electrolyte salt and electrode material that is fabricated from isotopically pure, or otherwise enriched in, lithium-6 (⁶Li) to increase power and life of the battery.

### FIELD

The present invention relates to advanced battery technology, and more particularly, to an advanced battery technology that uses isotopically pure ⁶lithium (⁶Li).

### BACKGROUND

Lithium ion (Li-ion) batteries use lithium mined from the Earth. The lithium mined from the Earth has natural abundance lithium, which is only between 3-8% ⁶Li. It should be noted that there are two stable isotopes of lithium—⁶Li and ⁷Li—with ⁷Li having an extra neutron compared to ⁶Li. Conventional Li-ion batteries use the natural abundance lithium, which is a mixture of ⁶Li and ⁷Li, but whose properties are primarily that of ⁷Li. These conventional Li-ion batteries are limited in discharge power and cycling life compared to ⁶Li batteries. The less massive ⁶Li ions enable faster charge transport (increased power), higher ionic diffusion (better low temperature performance) and less electrode stress (longer life) then compared to natural abundance lithium batteries.

Accordingly, an improved battery technology that uses isotopically pure or enriched ⁶Li may be more beneficial.

### SUMMARY

Certain embodiments of the present invention may provide solutions to the problems and needs in the art that have not yet been fully identified, appreciated, or solved by current advanced battery technologies. For example, some embodiments of the present invention pertain to advanced battery technology that uses isotopically pure ⁶Li. For example, some embodiments increase the power of a Li-ion battery as well as increase the cycle life of the battery.

In an embodiment, a battery may include electrolyte salt and electrode material fabricated from isotopically pure or otherwise enriched in ⁶Li to increase power and life of the battery.

In another embodiment, an isotopically pure battery or battery enriched in ⁶Li is configured to increase round trip energy efficiency of storage, increase usable power of the ⁶Li battery, and reduce wear and mechanical degradation on the ⁶Li.

In yet another embodiment, a battery enriched in isotopically ⁶Li is configured to increase round trip energy efficiency of storage, increase usable power of the ⁶Li battery, and reduce wear and mechanical degradation on the ⁶Li.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is block diagram illustrating a battery, according to an embodiment of the present invention.

FIG. 2A is a diagram illustrating a battery having a plurality of layers diffused with ⁶Li and ⁷Li, according to an embodiment of the present invention.

FIG. 2B is a diagram illustrating a battery having a plurality of layers diffused with ⁶Li, according to an embodiment of the present invention.

### DETAILED DESCRIPTION OF THE EMBODIMENTS

Some embodiments generally pertain to an isotopically pure or isotopically enriched ⁶Li-ion battery. Lithium has been shown to demonstrate the kinetic isotope effect in both diffusion transport in liquid electrolytes as well as in solid state electrolytes. This effect means that transport of the less massive ⁶Li ion is faster than for the more massive ⁷Li ion.

Additionally, ⁶Li has been shown to be preferentially intercalated into battery materials as compared to ⁷Li, causing less strain and fatigue on the battery material during cycling. The effect increases the round trip energy efficiency of storage, increases the usable power of a ⁶Li battery, and reduces the wear or mechanical degradation on the battery and battery materials from operation.

In certain embodiments, the battery uses electrolyte salts and electrode materials fabricated using isotopically pure or isotopically enriched ⁶Li precursors as opposed to natural abundance Li. In nature, the fraction of Li as ⁶Li varies from 3-8%. These natural sources have varying isotopic abundances, specifically due to the kinetic isotope effect in nature enriching sources in ⁶Li.

Li-ion batteries are the key driving technology for electric vehicles. They are also key components in the personal electronics industry. The use of ⁶Li in battery technology will increase both the power and cycle life of any Li-ion batteries where it used.

Since ⁶Li is less massive than ⁷Li, ⁶Li is transported more quickly through ion conducting materials in solid state batteries. The diffusion flux of lithium through a medium (electrolyte or solid electrode) is partially dependent on lithium's diffusivity, which is inversely proportional to species mass. Although other aspects can affect diffusive flux in a lithium ion battery, such as concentration and electric field (Nernst-Planck equation), with all other things being equal, the decreased ion mass of ⁶Li results in a higher ionic flux as compared to that of ⁷Li. Thus, the diffusion of the charge carrying species, ⁶Li, will be higher than a comparable ⁷Li ion.

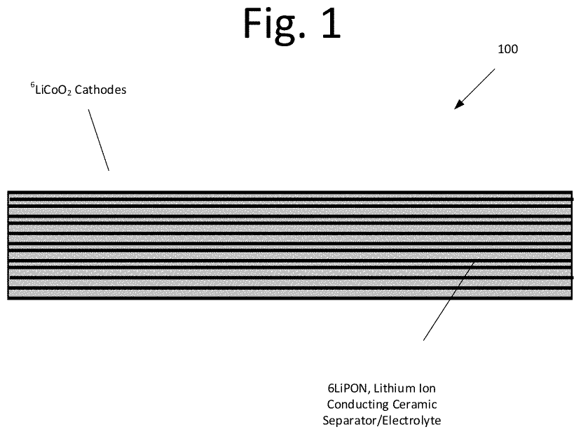

FIG. 1 is a block diagram illustrating a battery 100, according to an embodiment of the present invention. In this embodiment, the separator and electrolyte are replaced with specific ⁶Li-based material. For example, the ⁶Li-based material may also be composed of lithium-6 aluminum titanium phosphate (LATP), lithium-6 phosphorous oxynitride (LiPON), lithium-6 super ion conductor (LISICON, Li₂₊₂ₓZn₁₋ₓGeO₄), lithium-6 lanthanum zirconium oxide (LLZO), or other lithium ion transporting material synthesized from ⁶Li precursors. In certain embodiments, however, a conventional separator and a conventional electrolyte liquid phase may be used provided that the salt is replaced with ⁶Li. For example, the liquid phase may be composed of lithium-6 hexafluorophosphate (⁶LiPF₆), lithium-6 perchlorate (⁶LiClO₄), lithium-6 tetrafluoroborate (⁶LiBF₄), and other conventional electrolyte salt ⁶Li analogues.

The cathode, when synthesized, may be composed of materials using ⁶Li. In FIG. 1, for example, the cathode may be composed of lithium-6 cobalt oxide (⁶LCO), however, other ⁶Li cathode materials may be used, such as lithium-6 manganese nickel oxide (⁶LMNO), lithium-6 iron phosphate (⁶LFP), lithium-6 nickel manganese cobalt oxide (⁶NMC), lithium-6 manganese oxide (⁶LMO), or other conventual cathode analogues synthesized using ⁶Li precursors. The anode may also be synthesized from ⁶Li materials. For example, the anode may be composed of lithium-6 metal (⁶Li(s)), lithium-6 titanite (⁶Li₂TiO₃), or other conventional anode analogues synthesized using ⁶Li precursors.

As briefly discussed above, state of the art lithium ion battery designs use natural abundance lithium, a mix of lithium-6 and lithium-7, but predominantly lithium-7, to the point where the physical and electrochemical properties of the battery are determined by the lithium-7 components. The small amount of ⁶Li present in natural abundance lithium materials means that the electrochemical properties of batteries made using natural abundance lithium will be that of the dominant ⁷Li. The electrochemical properties are ensemble properties, and all effects are proportional to the individual lithium populations. Use of the ⁶Li isotope can apply to both conventional and novel lithium ion battery manufacturing. Conventional manufacturing of a lithium-6 based lithium ion battery may encompass prismatic assembly or cylindrically rolled assembly of cathode, anode, and separator with introduction of a liquid electrolyte. These materials can contain isotopically pure or enriched ⁶Li, but otherwise use conventional battery assembly and design features and processes. This novel lithium ion battery assembly may also encompass evaporation of lithium-6 metal onto a current collector, physical vapor deposition of lithium-6-based ceramic solid electrolytes or cathode materials, or chemical vapor deposition or UV curing of lithium-6-based solid polymer electrolytes.

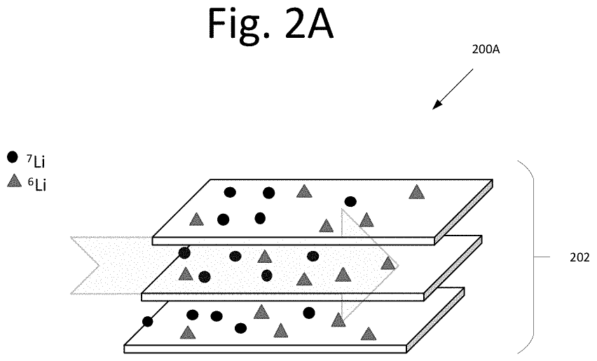

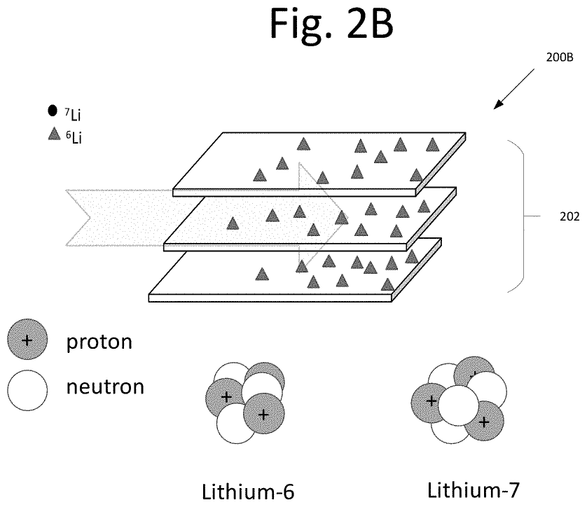

FIG. 2A is a diagram illustrating a battery 200A having a plurality of layers with ⁶Li and ⁷Li, according to an embodiment of the present invention. In this embodiment, a plurality of layers 202 are shown for both the anode and cathode. These layers 202 are the chemical layers of the material, with the atoms existing in sheets.

Battery 200A using a mixture of lithium-6 and lithium-7 will have properties based on the proportional mix of the two species. As shown in FIG. 2A, during intercalation into the solid planes of a lithium ion battery material, lithium-6 diffuses into the material faster and farther than lithium-7 does under electric fields and diffusion gradients. Thus, lithium-6 batteries will supply higher energy and power in lower temperatures, which is an important consideration for both conventional and solid-state lithium ion batteries. In addition, because of its lower mass, ⁶Li will impart less mechanical stress during intercalation into, and deintercalation from, electrodes. By increasing the speed of diffusion, the ⁶Li battery operates at a higher power than a conventional battery. By increasing the depth of diffusion in a given time, ⁶Li requires less overpotential for intercalation, and thus a ⁶Li battery operates more efficiently than a conventional lithium battery.

FIG. 2B shows a ⁶Li battery, with the replacement of the more massive ⁷Li with ⁶Li. This may result in further intercalation of lithium ions for the same electromotive force. The less massive ⁶Li allows for the battery to operate at a higher power level. The specific capacity for one mole of naturally abundant lithium (6.941 g/mol) is 3860 mAh/g. In comparison, the specific capacity for one mole of ⁶Li (6.015 g/mol) is 4454 mAh/g; assuming similar operating voltages, temperatures, and C-rates when implemented into lithium ion batteries, the higher specific energy/capacity of lithium-6 allow for higher operating powers and less massive batteries. In addition, ⁶Li causes less physical and mechanical stress on the intercalation material, extending the life of the battery.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A battery, comprising:
electrolyte and electrode material fabricated from isotopically pure or enriched lithium-6 (⁶Li) to increase power and life of the battery.

2. The battery of claim 1, further comprising:
⁶Li-based material composed of lithium-6 aluminum titanium phosphate (LATP), lithium-6 phosphorous oxynitride (LiPON), lithium-6 super ion conductor (Lisicon, Li₂₊₂ₓZn₁₋ₓGeO₄), lithium-6 lanthanum zirconium oxide (LLZO), lithium-6 polymer gels or solids or a lithium ion transporting material synthesized from ⁶Li precursors.

3. The battery of claim 1, further comprising:
a separator and an electrolyte liquid phase composed of lithium-6 hexafluorophosphate (⁶LiPF₆), lithium-6 perchlorate (⁶LiClO₄), lithium-6 tetrafluoroborate (⁶LiBF₄), and electrolyte salt ⁶Li analogues.

4. The battery of claim 1, further comprising:
a cathode being composed of lithium-6 cobalt oxide (⁶LCO), lithium-6 manganese nickel oxide (⁶LMNO), lithium-6 iron phosphate (⁶LFP), lithium-6 nickel manganese cobalt oxide (⁶NMC), lithium-6 manganese oxide (⁶LMO), or cathode analogues synthesized using ⁶Li precursors.

5. The battery of claim 1, further comprising:
the anode being composed of lithium-6 metal (⁶Li(s)), lithium-6 titanite (⁶Li₂TiO₃), or other anode analogues synthesized using ⁶Li precursors.

6. An apparatus, comprising:
an isotopically pure battery or battery enriched in lithium-6 (⁶Li) configured to increase round trip energy efficiency of storage, increase usable power of the ⁶Li battery, and reduce wear and mechanical degradation on the ⁶Li.

7. The apparatus of claim 6, wherein the ⁶Li battery uses electrolyte salts, electrolytes, and electrode materials fabricated using isotopically pure or enriched ⁶Li precursors.

8. The apparatus of claim 6, wherein the ⁶Li battery comprises ⁶Li-based material, effectively replacing a separator component and electrolyte component.

9. The apparatus of claim 8, wherein the ⁶Li-based material is composed of lithium-6 aluminum titanium phosphate (LATP), lithium-6 phosphorous oxynitride (LiPON), lithium-6 super ion conductor (LISICON, Li₂₊₂ₓZn₁₋ₓGeO₄), lithium-6 lanthanum zirconium oxide (LLZO), or lithium ion transporting material synthesized from ⁶Li precursors.

10. The apparatus of claim 6, wherein, when a separator and an electrolyte liquid phase is used in the ⁶Li battery, the liquid phase is composed of lithium-6 hexafluorophosphate (⁶LiPF₆), lithium-6 perchlorate (⁶LiClO₄), lithium-6 tetrafluoroborate (⁶LiBF₄), and other electrolyte salt ⁶Li analogues.

11. The apparatus of claim 6, wherein the ⁶Li battery comprises a cathode, when synthesized, is composed of materials using ⁶Li.

12. The apparatus of claim 11, wherein the material is composed of lithium-6 cobalt oxide (⁶LCO).

13. The apparatus of claim 11, wherein the material is composed of lithium-6 manganese nickel oxide (⁶LMNO), lithium-6 iron phosphate (⁶LFP), lithium-6 nickel manganese cobalt oxide (⁶NMC), lithium-6 manganese oxide (⁶LMO), or other cathode analogues synthesized using ⁶Li precursors.

14. The apparatus of claim 6, wherein the ⁶Li battery comprises an anode, when synthesized, is composed of materials using ⁶Li.

15. The apparatus of claim 14, wherein the anode is composed of lithium-6 metal (⁶Li(s)), lithium-6 titanite (⁶Li₂TiO₃), or other anode analogues synthesized using ⁶Li precursors.

16. The apparatus of claim 6, wherein ⁶Li battery encompasses evaporation of lithium-6 metal onto a current collector, physical vapor deposition of lithium-6-based ceramic solid electrolytes or cathode materials, or chemical vapor deposition or UV curing of lithium-6-based solid polymer electrolytes.

17. The apparatus of claim 6, wherein the ⁶Li in the battery imparts less mechanical stress during intercalation into, and deintercalation from, electrodes.

18. The apparatus of claim 6, wherein the ⁶Li replaces a more massive ⁷Li component in the battery resulting in further intercalation of lithium ions for a same electromotive force.

19. The apparatus of claim 6, wherein the ⁶Li is configured to cause the battery to operate at a higher power level than a battery comprising of ⁷Li.

20. An apparatus, comprising:
a battery enriched in isotopically lithium-6 (⁶Li) configured to increase round trip energy efficiency of storage, increase usable power of the ⁶Li battery, and reduce wear and mechanical degradation on the ⁶Li.
